(19) United States
(12) Patent Application Publication
(10) Pub. No.: US 2026/0106440 A1
(43) Pub. Date: Apr. 16, 2026

(54) ELECTRICAL BOX

(71) Applicant: Pontiac Trail Products, LLC, Novi, MI (US)

(72) Inventors: Michael W. Maurer, Novi, MI (US); Christopher David Meeks, Greensboro, NC (US)

(73) Assignee: Pontiac Trail Products, LLC, Novi, MI (US)

(21) Appl. No.: 19/359,090

(22) Filed: Oct. 15, 2025

Related U.S. Application Data
(60) Provisional application No. 63/707,829, filed on Oct. 16, 2024.

(51) Int. Cl. H02G 3/14; H02G 3/08; H02G 3/10

(52) U.S. Cl. CPC H02G 3/14; H02G 3/081; H02G 3/088; H02G 3/10

(57) ABSTRACT

Presented are multipiece, surface-mount electrical boxes, methods for making/using such electrical boxes, and electrical systems equipped with such electrical boxes. A representative electrical box is a bipartite assembly that includes a backplate and a faceplate. The backplate includes a planar body that seats against a load-bearing support surface, such as an exterior face of a building wall. The faceplate includes a dome-shaped central hub with a mounting flange that projects outward from the central hub and mounts to the support surface. The mounting flange includes a recessed backstop that receives therein and surrounds the backplate. A set of flexible press-fit tabs may project from the backplate's planar body such that the backplate is slidably received in the recessed backstop and the press-fit tabs interference fit with the interior walls of the recessed backstop. The backplate and faceplate may each be integrally formed from a polymeric material as a single-piece structure.

### CLAIM OF PRIORITY AND CROSS-REFERENCE TO RELATED APPLICATION

This application claims the benefit of and priority to U.S. Provisional Ser. No. 63/707,829, which was filed on Oct. 16, 2024, and is incorporated herein by reference in its entirety and for all purposes.

### TECHNICAL FIELD

The present disclosure relates generally to electrical boxes for housing electrical components. More specifically, aspects of this disclosure relate to surface-mount weatherproof electrical boxes that affix onto the exterior of buildings and other structures.

### INTRODUCTION

An electrical box is a protective container that is used in electrical systems to house light switches (switch box), power outlets (outlet box), electrical connections (junction box), light fixtures (ceiling box), and other electrical hardware. Many electrical boxes are hexahedral receptacles that are either stamped, e.g., from aluminum or steel, or molded, e.g., from plastic resin or fiber-reinforced polymer, as a solitary one-piece structure. During installation, a conventional electrical box is fastened to a frame stud inside a building's wall structure such that an open face of the box sits generally flush with and opens through an exterior surface of the wall. With the added clearance behind the wall substrate, recess-mount electrical boxes tend to have narrower and deeper designs to fit within the small gaps between wall studs while ensuring sufficient internal packaging volume. Most electrical boxes are not weatherproof or waterproof designs since they are located inside the building and, thus, are not exposed to inclement weather conditions.

### SUMMARY

Presented herein are multipiece electrical boxes with surface-mount backplates and weather-resistant faceplates, methods for making and methods for using such electrical boxes, and electrical systems equipped with such electrical boxes. When installing building siding, for example, there is often a need for surface-mount outlet boxes for housing electrical outlets that are accessible from the exterior of a building. For such applications, disclosed electrical boxes may be designed to fit inside a siding mounting block that provides a weatherproof enclosure with an aesthetically pleasing appearance. Unlike traditional recess-mount electrical boxes, disclosed electrical boxes may be installed on top of the wall substrate and, if desired, may include a single penetration for receiving electrical wires. Since such surface-mount electrical boxes are not recessed into the wall, they may have a shallow form factor with an expanded footprint. A deep electrical box design may not be desirable when secured onto the wall's exterior because the box may obtrude from the building and create an unappealing appearance.

To ensure sufficient packaging volume with a low profile, the electrical box may be wider and/or taller than traditional box designs. In addition, an optional electrical box window may open through a frontmost face of the faceplate to provide access to the interior volume of the electrical box. The length and width of the window opening may be smaller than the overall length and width of the electrical box. For manufacturing feasibility, disclosed electrical boxes may be bipartite assemblies that consist essentially of a wall-mounted backplate that supports thereon and snap-fits to a complementary faceplate. The faceplate and backplate may each be injection molded as a single-piece, unitary structure from a rigid polymeric material, such as polypropylene (PP) or polyvinyl chloride (PVC). To eliminate the need for gaskets or seals, a rearmost face of the faceplate may be integrally formed with an annulus-shaped recessed backstop that seats therein the backplate to prevent the intrusion of water, snow, and debris into the electrical box.

Aspects of this disclosure are directed to electrical boxes for exterior faces of building walls. In an example, an electrical box includes a backplate that permanently or releasably attaches thereto a faceplate. The backplate includes a substantially flat backplate body that seats against and, optionally, mounts to a wall surface of a wall. The faceplate has a “hat-like” geometry with a dome-shaped central hub and a mounting flange that projects outward from the central hub's outer perimeter. The mounting flange is configured to securely mount to the wall surface, e.g., via a set of threaded fasteners. In addition, the mounting flange includes a recessed backstop that nests therein and partially or completely surrounds the backplate. The backstop may have a polygonal-annulus profile that extends continuously around and circumscribes an open back face the central hub. The electrical box may be a bipartite assembly that consists essentially of the backplate and the faceplate.

Aspects of this disclosure are also directed to surface-mount electrical box assemblies that securely mount onto exterior faces of building walls. In an example, a surface-mount electrical box includes a backplate that is integrally formed, in whole or in part, from a polymeric material as a single-piece structure with a planar backplate body and a set of flexible press-fit tabs that projects out from the backplate body's outer perimeter. The backplate's planar body is structurally configured to seat flush against and mount to an exterior surface of a building wall. The electrical box also includes a faceplate that is integrally formed, in whole or in part, from a polymeric material as a single-piece structure with a dome-shaped central hub, a box window extending through the central hub, and an annular mounting flange that projects transversely outward from the central hub's outer perimeter. The mounting flange includes an annular recessed backstop that slidably receives therein and circumscribes the backplate such that the press-fit tabs interference fit with the interior walls of the recessed backstop.

Further aspects of this disclosure are directed to methods for fabricating and methods for installing any of the herein described electrical boxes. In an example, a method is presented for manufacturing an electrical box, e.g., that mounts onto a support surface via one or more fasteners. This representative method includes, in any order and in any combination with any of the above and below disclosed options and features: forming a backplate with a planar backplate body configured to seat against a wall surface of a wall; forming a faceplate with a dome-shaped central hub and a mounting flange projecting outward from an outer perimeter of the dome-shaped central hub and configured to mount to the wall surface of the wall, the mounting flange including a recessed backstop; and locating the backplate inside the recessed backstop of the faceplate such that the mounting flange at least partially surrounds the backplate.

For any of the herein described electrical boxes, systems, and methods, the backplate may include a plurality of flexible press-fit tabs that project from the backplate's planar body. In this instance, the backplate is slidably received in the recessed backstop such that these press-fit tabs interference fit with a plurality of interior walls of the recessed backstop. As a further option, the press-fit tabs may project transversely or obliquely outward from and are spaced from one another around the outer perimeter of the backplate's planar body. The faceplate's mounting flange may include one or more locking teeth that snap-lock with one or more of the backplate's press-fit tabs.

For any of the herein described electrical boxes, systems, and methods, the backplate's planar body may include opposing first (front) and second (back) faces, and the faceplate's mounting flange may include opposing first (front) and second (back) faces. The backplate's second (back) face may lay substantially flush with the mounting flange's second (back) face when the backplate is located in the mounting flange, e.g., such that both the backplate and mounting flange lay flush against the wall surface. As a further option, the backplate's planar body may include multiple fastener holes that each receives therethrough a respective fastener for fastening the backplate to the wall surface. In the same vein, the faceplate's mounting flange may include multiple fastener holes that each receives therethrough a respective fastener for fastening the faceplate to the wall surface.

For any of the herein described electrical boxes, systems, and methods, the backplate may include a sealing rib that projects from a rear face of the backplate's planar body. The backplate's sealing rib is structurally configured to press against and seal to the wall surface. In the same vein, the faceplate may include a sealing rib that projects from a rear face of the faceplate's mounting flange. Like the backplate sealing rib, the faceplate's sealing rib is structurally configured to press against and seal to the wall surface. These sealing ribs may have annular profiles that extend continuously around the faceplate and backplate. In this regard, the electrical box may be characterized by an absence of gaskets, seal rings, adhesive sealants, etc., for fluidly sealing the faceplate to the backplate or for fluidly sealing the electrical box to the wall surface.

For any of the herein described electrical boxes, systems, and methods, the backplate may include an array of wire-holding tabs that project from a front face of the backplate's planar body. Each wire-holding tab is structurally configured to grasp one or more electrical wires and thereby secure the wire(s) to the backplate. As a further option, the faceplate may include a box window that extends through a frontmost face of the central hub. The box window may have a window area (length and width) that is less than a faceplate area (length and width) of the faceplate. It may be desirable that the backplate be integrally formed, e.g., via injection molding, as a single-piece, unitary structure from a polymeric material, such as PVC or PP. Likewise, it may be desirable that the faceplate be integrally formed, e.g., via injection molding, as a single-piece, unitary structure from a polymeric material, such as PVC or PP.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a front-view illustration of a representative multipiece, surface-mount electrical box assembly in accordance with aspects of the present disclosure.

FIG. 2 is a side-view illustration of the representative electrical box assembly of FIG. 1 shown mounted onto a load-bearing support structure.

FIG. 3 is an elevated, front perspective-view illustration of the representative electrical box assembly of FIG. 1.

FIG. 4 is a rear-view illustration of the representative electrical box assembly of FIG. 1.

FIG. 5 is an elevated, rear perspective-view illustration of the representative electrical box assembly of FIG. 1.

FIG. 6 is another front-view illustration of the representative electrical box assembly of FIG. 1 shown with section lines for the views presented in FIGS. 7 and 8.

FIG. 7 is a side-view illustration of the representative electrical box assembly of FIG. 1 taken in cross-section along line A-A of FIG. 6.

FIG. 8 is a bottom, side-view illustration of the representative electrical box assembly of FIG. 1 taken in cross-section along line B-B of FIG. 6.

FIG. 9 is a front-view illustration of the representative electrical box faceplate (or “cover”) of FIG. 1.

FIG. 10 is an elevated, front perspective-view illustration of the representative electrical box faceplate of FIG. 1.

FIG. 11 is a rear-view illustration of the representative electrical box faceplate of FIG. 1.

FIG. 12 is an elevated, rear perspective-view illustration of the representative electrical box faceplate of FIG. 1.

FIG. 13 is a front-view illustration of the representative electrical box backplate (or “mounting plate”) of FIG. 1.

FIG. 14 is an elevated, front perspective-view illustration of the representative electrical box backplate of FIG. 1.

FIG. 15 is a rear-view illustration of the representative electrical box backplate of FIG. 1.

FIG. 16 is an elevated, rear perspective-view illustration of the representative electrical box backplate of FIG. 1.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Technical Field, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the terms “including,” “containing,” “comprising,” “having,” and the like, shall each mean “including without limitation. ” Moreover, words of approximation, such as “about,” “almost,” “substantially,” “generally,” “approximately,” and the like, may each be used herein to denote “at, near, or nearly at” or “within 0-5% of” or “the same or practically the same as” or “within acceptable manufacturing tolerances” or any logical combination thereof, for example.

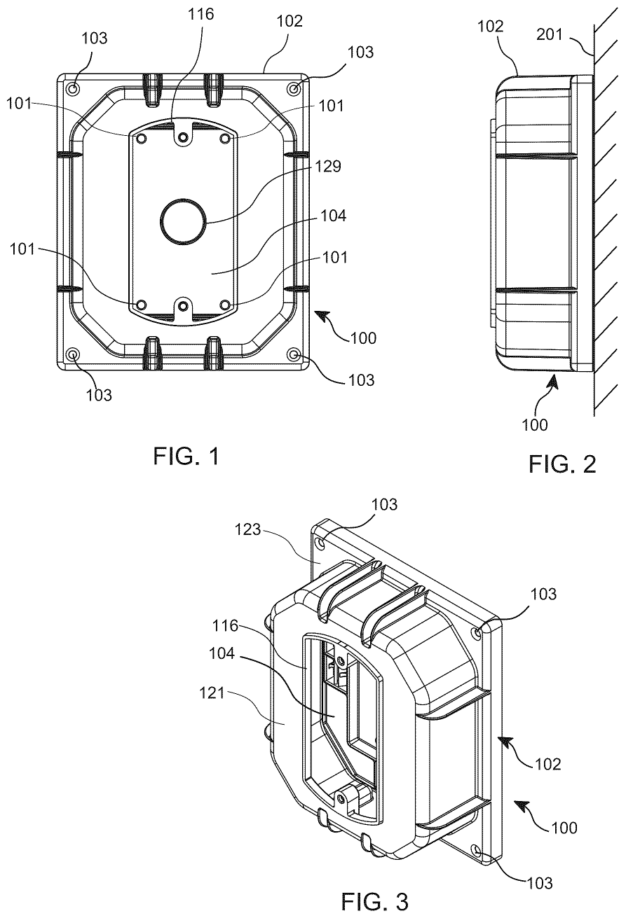

Referring now to the drawings, wherein like reference numbers refer to like features throughout the several views, there is shown in FIG. 1 a representative electrical box assembly, which is designated generally at (100) and portrayed herein for purposes of discussion as a surface-mount, weatherproof outlet box. The illustrated electrical box assembly (100)—also referred to herein as “electrical box” or “box” for short—is merely an exemplary application with which novel aspects of this disclosure may be practiced. In the same vein, utilization of the present concepts for a weatherproof outlet box that mounts onto the exterior of a building for housing electrical outlets should also be appreciated as a non-limiting implementation of disclosed concepts. As such, it will be understood that aspects of this disclosure may be implemented for other electrical box form factors, may be mounted both inside and outside of a building, and may be utilized for housing any logically relevant type of electrical component.

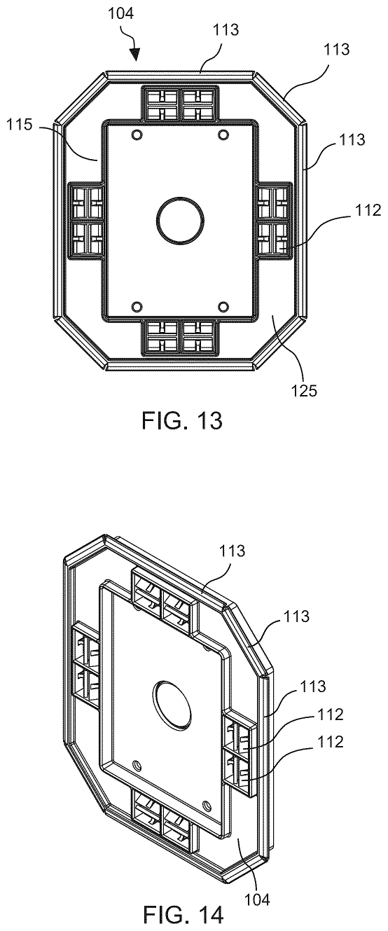

The electrical box (100) of FIG. 1 is portrayed as bipartite assembly that may consist essentially of a protective faceplate (102) that press-fits onto and covers a wall-mounted backplate (104). As best seen in FIG. 3, the faceplate (102) has a “hat-like” geometry with a decahedral dome-shaped central hub (121) and a hexahedral mounting flange (123) that projects outward from and surrounds an outer perimeter of a rearmost edge of the central hub (121). The backplate (104), in contrast, includes a substantially flat and surface-textured decahedral backplate body (125) (FIG. 13) that seats against and mounts to a wall surface of a wall (201). For instance, the faceplate (102) may include a set of (four) fastener holes (103) that each receives therethrough a respective fastener (e.g., Phillips-head wood screws) for directly attaching the whole assembly (100) to an exterior face of the wall (201), instead of using cover clips for retaining the faceplate (102). Likewise, the backplate (104) may include a set of (four) blind holes (101) each having a thin, penetrable base that receives therethrough a respective fastener for mounting the faceplate (102) onto the wall (201). It should be appreciated that the shapes and sizes of the faceplate (102) and backplate (104) may be adapted and scaled to an assortment of different applications.

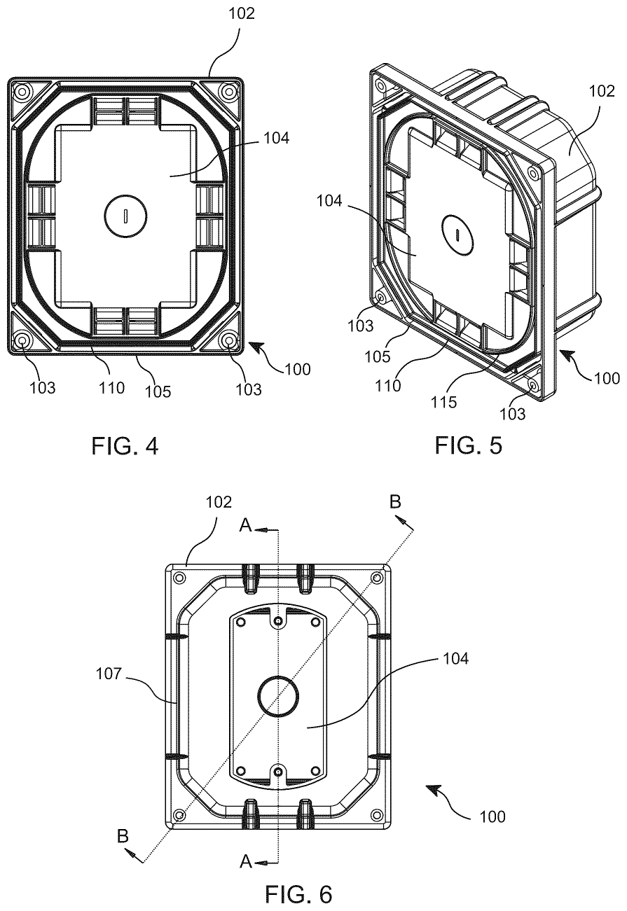

FIGS. 4 and 5 provide rear views of the electrical box (100) to show a faceplate sealing rib (105) that projects from a rear face of the faceplate's mounting flange (123). Sealing rib (105) may have a rectangular-annulus profile that extends continuously around the outer perimeter of the faceplate's mounting flange (123). This rib (105) is designed to press against the exterior face of the wall (201) when the electrical box (100) is installed to help prevent water, snow, and debris from entering the internal volume of the assembled box (100). Likewise, the backplate (104) has a backplate sealing rib (110) that projects from a rear face of the backplate's planar body (125). This rib (110) also presses against the wall (201) when the electrical box (100) is installed to help prevent water from entering the box (100) through wire-holding tabs (112). Sealing rib (110) may have an octagonal-annulus profile that extends continuously around the outer perimeter of the backplate's planar body (125). With this design, the faceplate's sealing rib (105) is located outward from and circumscribes the backplate's sealing rib (110). Integration of one or both sealing ribs (105), (110) into the electrical box assembly (100) may eliminate the need for superfluous gaskets, seal rings, adhesive sealants, etc.

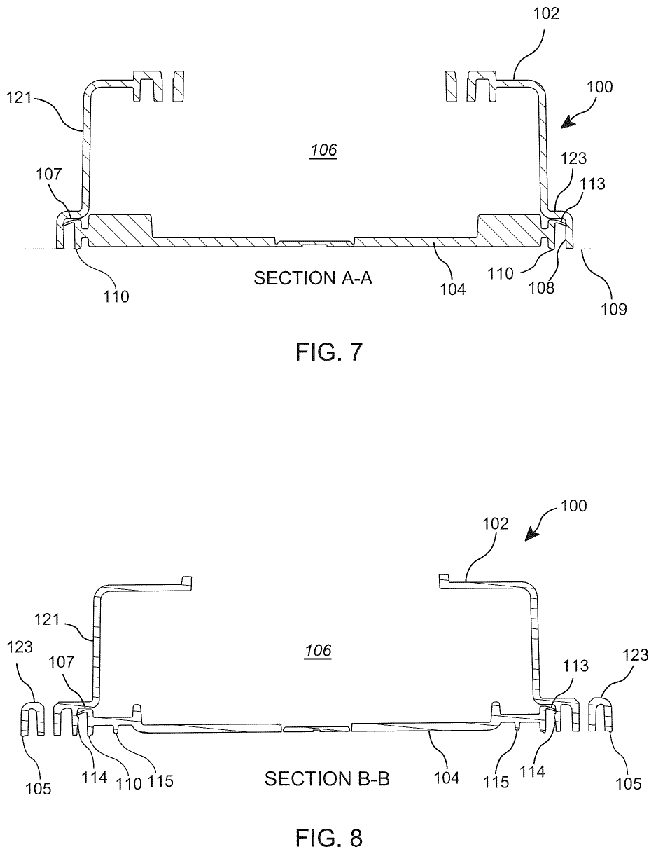

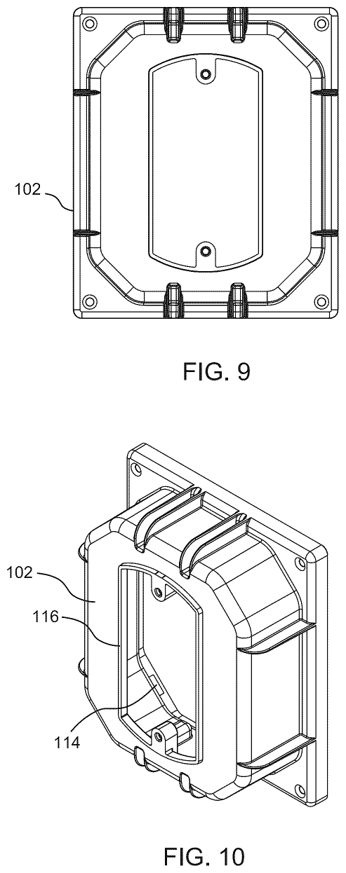

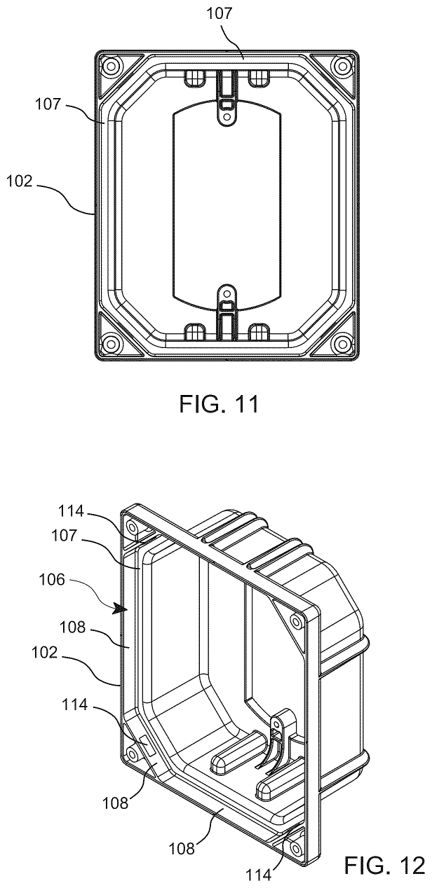

The mounting flange (123) of the faceplate (102) includes a recessed backstop (107) that nests therein and surrounds the backplate (104). As best seen with collective reference to FIGS. 7 and 12, for example, the backstop (107) is recessed into the rear face of the mounting flange (123) and has an octagonal annulus-shaped profile that is complementary to the octagonal perimeter of the backplate (104). The recessed backstop (107) allows the backplate (104) to nest inside of the faceplate (102) and create a serpentine “S” path for guiding water around and out of the electrical box (100), which helps to deter water intrusion. The recessed backstop (107) may be sufficiently deep to ensure that when the backplate (104) is inserted into the back of the mounting flange (123), the rear face of the backplate (104) lays substantially flush with the rear face of the faceplate (102). In so doing, both the faceplate (102) and backplate (104) may lay substantially flush against the exterior face of the wall (201).

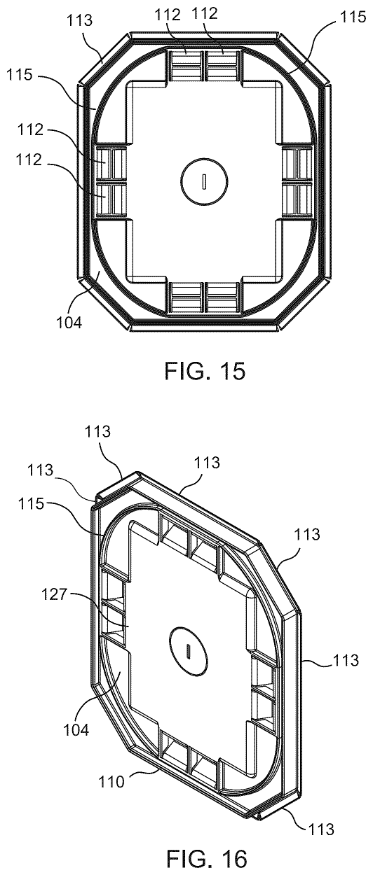

To releasably attach the faceplate (102) to the backplate (104), the electrical box assembly (100) may employ a hybrid interference-fit, snap-fit locking system that secures the backplate (104) inside the backstop (107). By way of example, and not limitation, the backplate (104) may include one or more flexible, press-fit tabs (113) that project from the backplate's planar body (125). As best seen in FIGS. 13-16, for example, a set of (eight) press-fit tabs (113) project transversely or obliquely outward from respective edges of the backplate's planar body (125) such that the tabs (113) are spaced from one another around the backplate body's (125) outer perimeter. By pressing the faceplate (102) against the backplate (104), or vice versa, the backplate's planar body (125) slides into the open rear face of the mounting flange (123). In so doing, the press-fit tabs (113) flex inward and press against inside surfaces of interior backstop walls (108) of the recessed backstop (107); this creates an interference fit between the tabs (113) and backstop (107), as best seen in FIGS. 7 and 8. In addition to securely attaching the faceplate (102) to the backplate (104), the interference fit also provides additional protection against water penetration.

In order to prevent inadvertent removal of the backplate (104) from inside the faceplate (102), the faceplate's mounting flange (123) may include one or more locking teeth (114) that snap-lock to one or more of the backplate's press-fit tabs (113). As best seen with collective reference to FIGS. 8 and 12, for example, a set of (four) locking teeth (114) project inward from select interior backstop walls (108) of the recessed backstop (107). Each locking tooth (114) may be oriented at a 45-degree angle relative to the mounting flange's side walls, e.g., to provide maximum rigidity. Upon insertion of the backplate (104) into the faceplate (102), four of the press-fit tabs (113) flex into snap-fit engagement with the four locking teeth (114). It is envisioned that the number and locations of the press-fit tabs (113) may be varied from that which are shown in the drawings. For instance, the backplate (104) may include a single, continuous press-fit tab (113) or four press-fit tabs (113) located along the major edges of the backplate body (125). As yet a further option, the locking teeth (114) may be altogether omitted from the electrical box (100), e.g., to simplify removal of the faceplate (102) from the backplate (104) after installation of the electrical box (100) onto the wall (201).

In addition to the sealing ribs (105), (110), the backplate (104) may include an optional water diversion rib (115) that projects from the rear face of the backplate's planar body (125). Unlike the polygonal profiles of the sealing ribs (105), (110), the water diversion rib (115) may have an elliptical-annulus profile that extends continuously around a set of wire-holding features (112) and a substantially flat central region (127) of the backplate's planar body (125). With this design, the backplate's outer sealing rib (110) is located outward from and circumscribes the backplate's inner diversion rib (115). In contrast to the two sealing ribs (105), (110), however, the diversion rib (115) does not touch the wall (201); rather, the diversion rib (115) is designed to divert water around the backplate's central region (127) and guide the water out of the electrical box (100) without entering the box's internal volume through the wire-holding features (112).

Unique to siding-installation applications, the electrical box assembly (100) may be specifically designed to install onto an exterior face of a wall (201) substrate on the outside of a commercial or residential building. For such designs, there may be a single penetration in the wall (201) substrate for passing therethrough electrical wires; conventional surface-mount outdoor box designs may have tubular constructions that allow the entire electrical box to act as a penetration in the wall. In contrast, the backplate (104) may include a reduced-diameter center through-hole (129) that aligns with the single penetration in the wall (201) for receiving the electrical wire(s). To provide access to the interior volume of the assembled electrical box (100), e.g., for manipulation of these wires, the faceplate (102) may include a central box window (116) that extends through a frontmost face of the dome-shaped central hub (121). The box window (116) may have a window area (length and width) that is less than a faceplate area (length and width) of the faceplate. An optional window cover (not shown) may be secured onto the faceplate (102) to cover the box window (116).

While many conventional electrical boxes are fabricated as a stamped or molded one-piece construction, the illustrated electrical box (100) is a multipiece design that includes at least the faceplate (102) and backplate (104). For simplicity of design and reduced unit cost, the electrical box (100) may be a bipartite assembly that consists essentially of the faceplate (102) and backplate (104). Once assembled, the faceplate (102) and backplate (104) cooperatively define the internal packaging volume (106) of the electrical box assembly (100). Faceplate fastener holes (103) may be located at the four corners of the mounting flange (123) to attach the electrical box assembly (100) to the wall (201) while helping to counteract inadvertent warpage of the faceplate (102) caused during part manufacture and ensure that the electrical box (100) seats flush against the wall (201).

The rearmost faces of the faceplate (102) and backplate (104) may be coplanar with each other to cooperatively define a box attachment plane (109), shown with a hidden plane line in FIG. 7. The attachment plane (109) may be substantially parallel to and coplanar with the exterior face of the wall (201). Both of the sealing ribs (105), (110) may protrude slightly past the box attachment plane (109) to sealingly abut and press into the wall (201) substrate. In some instances, the faceplate sealing rib (105) may be reshaped and repositioned to adjoin and extend continuously around the recessed backstop (107) region of the mounting flange (123). The faceplate sealing rib (105) may be designed to have an interference-fit interface with the wall (201) substrate.

The recessed backstop (107) may include eight interconnected backstop walls (108) that cooperatively define a frame-like support structure for slidably receiving therein the backplate (104). As best seen in FIGS. 7 and 8, the backstop (107) is recessed from the box attachment plane (109) such that the entire backplate (104) is nested inside the faceplate (102). It is designed to allow the Backplate (104) to install inside the Faceplate (102). The backplate (104) may have a respective backplate attachment plane that is either designed to be flush with or slightly recessed in ward from the box attachment plane (109). While shown as a single, continuous rib with an octagonal profile, the backplate sealing rib (110) may take on other shapes, sizes, and locations as well as take on discontinuous, multipiece designs. The backplate sealing rib (110) helps to prevent the unwanted ingress of water, debris, etc., through the wire-holding features (112). While shown as flexible retention tabs, the wire-holding features (112) may include integral wire clamps, hooks, knockouts, cutouts, etc., for inserting and supporting wiring in the electrical box (100).

The backplate sealing rib (110) may be designed to be flush with or slightly recessed inward from the faceplate sealing rib (105), for example, to ensure that the backplate sealing rib (110) does not interfere with the faceplate sealing rib (105) pressing against and sealing to the wall (201). In the event the backplate (104) is not fully inserted into the faceplate (102), securing the electrical box assembly (100) onto the wall (201) substrate will cause the wall (201) to press the backplate (104) into the faceplate (102) until the backplate's attachment plane is coplanar with the box attachment plane (109).

The press-fit ribs (113) may substantially surround the outermost perimeter of the backplate (104) such that the ribs (113) are interposed between the backstop walls (108) and the backplate body (125). Each press-fit rib (113) may have a reduced thickness relative to the peripheral wall of the backplate body (125) from which it projects to enable elastic deflection of the rib (113). Moreover, the press-fit ribs (113) may project at an oblique angle from the backplate's planar body (125) such that the ribs (113) curve in a direction opposite that of the direction for insertion of the backplate (104) into the faceplate (103). The total width and height of the backplate (104) may be slightly larger than the total width and height of the recessed backstop (107) such that the press-fit ribs (113) deflect and frictionally engage the backstop walls (108) when the backplate (104) is slid into the faceplate (102). A small cutout or gap may be located at each corner or curve of the backplate body (125) to ensure a universal sealing across each flat section of the press-fit ribs (113). In addition to providing the primary mechanism for attaching the backplate (104) to the faceplate (102), the ribs (113) may also serve as a layer of water protection where the two parts meet.

For purposes of installation, the electrical box (100) may be preassembled by firmly pressing the backplate (104) into the recessed backstop (107) of the faceplate (102). The assembled box (100) is then mounted as a unit onto the wall (201) by torquing threaded fasteners through the faceplate fastener holes (103). Alternatively, the backplate (104) may first be mounted onto the wall (201) by torquing threaded fasteners through the backplate's fastener holes (101). The electrical box (100) is thereafter assembled by firmly pressing the faceplate (102) onto the surface-mounted backplate (104). To more rigidly secure the backplate (104) to the faceplate (102), select ones of the press-fit tabs (113) may snap-lock to respective locking teeth (114) inside the recessed backstop (107). The snap-fit interface between the ribs (113) and teeth (114) may act as a secondary mechanism for attaching the backplate (104) to the faceplate (102). In addition to preventing the backplate (104) from unintentionally disconnecting from the faceplate (102), these locking teeth (114) may also provide operators with a tactile “snap” cue that confirms the backplate (104) has been properly installed into the faceplate (102) during assembly of the box (100).

Each of the wire-holding features (112) may have a respective opening through which wires may be passed into the internal volume (106) of the electrical box assembly (100). The type, number, and locations of the wire-holding features (112) may be adapted to a variety of different intended applications.. A water diversion rib (115) integral to and projecting from the rear face of the backplate (104) may surround the wire-holding features (112) to block possible water intrusion points. In the event water penetrates the faceplate's sealing rib (105) and the backplate's sealing rib (110), the water diversion rib (115) provides another fluid barrier to the wire-holding features (112). Water flowing between the electrical box assembly (100) and the wall (201) may change momentum when passing over these ribs (115); falling with gravity will be the path of least resistance for guiding the water away from the wire-holding features (112) and out of the electrical box (100).

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. An electrical box, comprising:
a backplate with a planar backplate body configured to seat against a wall surface of a wall; and
a faceplate with a dome-shaped central hub and a mounting flange projecting outward from the dome-shaped central hub and configured to mount to the wall surface, the mounting flange including a recessed backstop receiving therein and at least partially surrounding the backplate.

2. The electrical box of claim 1, wherein the backplate includes a plurality of flexible press-fit tabs projecting from the planar backplate body, and wherein the recessed backstop slidably receives therein the backplate such that the flexible press-fit tabs interference fit with a plurality of interior walls of the recessed backstop.

3. The electrical box of claim 2, wherein the press-fit tabs project outward from and are spaced from one another around an outer perimeter of the planar backplate body.

4. The electrical box of claim 1, wherein the planar backplate body of the backplate includes opposing first and second backplate faces, and the mounting flange of the faceplate includes opposing first and second flange faces, the second backplate face being substantially flush with the second flange face when the backplate is located in the mounting flange of the faceplate.

5. The electrical box of claim 1, wherein the mounting flange of the faceplate includes a plurality of fastener through holes each configured to receive therethrough a respective first fastener to thereby mount the faceplate to the wall surface of the wall.

6. The electrical box of claim 5, wherein the planar backplate body of the backplate includes a plurality of fastener blind holes each configured to receive therethrough a respective second fastener to thereby mount the backplate to the wall surface of the wall.

7. The electrical box of claim 1, wherein the backplate includes a backplate sealing rib projecting from a rear backplate face of the planar backplate body, the backplate sealing rib configured to press against and seal to the wall surface of the wall.

8. The electrical box of claim 1, wherein the faceplate includes a faceplate sealing rib projecting from a rear flange face of the mounting flange, the faceplate sealing rib configured to press against and seal to the wall surface of the wall.

9. The electrical box of claim 1, characterized by an absence of a gasket, an adhesive sealant, and a seal ring fluidly sealing the faceplate to the backplate.

10. The electrical box of claim 1, wherein the backplate includes a plurality of wire-holding tabs projecting from a front backplate face of the planar backplate body, each of the wire-holding tabs configured to hold an electrical wire.

11. The electrical box of claim 1, wherein the faceplate further includes a box window extending through a frontmost face of the dome-shaped central hub, the box window having a window area less than a faceplate area of the faceplate.

12. The electrical box of claim 1, wherein the backplate is integrally formed as a first single-piece structure with a first polymeric material.

13. The electrical box of claim 12, wherein the faceplate is integrally formed as a second single-piece structure with a second polymeric material.

14. A surface-mount electrical box assembly for an exterior surface of a building wall, the surface-mount electrical box assembly comprising:
a backplate integrally formed from a first polymeric material as a first single-piece structure with a planar backplate body configured to seat flush against and mount to the exterior surface of the building wall, and a plurality of flexible press-fit tabs projecting out from an outer perimeter of the planar backplate body; and
a faceplate integrally formed from a second polymeric material as a second single-piece structure with a polyhedral dome-shaped central hub, a box window extending through the central hub, and an annular mounting flange projecting transversely outward from an outer perimeter of the central hub, the mounting flange including an annular recessed backstop slidably receiving therein and circumscribing the backplate such that the flexible press-fit tabs interference fit with a plurality of interior walls of the recessed backstop.

15. A method of manufacturing an electrical box, the method comprising:
forming a backplate with a planar backplate body configured to seat against a wall surface of a wall;
forming a faceplate with a dome-shaped central hub and a mounting flange projecting outward from the dome-shaped central hub and configured to mount to the wall surface, the mounting flange including a recessed backstop; and
locating the backplate inside the recessed backstop of the faceplate such that the mounting flange at least partially surrounds the backplate.

16. The method of claim 15, wherein the backplate includes a plurality of flexible press-fit tabs projecting from the planar backplate body, and wherein the recessed backstop slidably receives therein the backplate such that the flexible press-fit tabs interference fit with a plurality of interior walls of the recessed backstop.

17. The method of claim 15, wherein the planar backplate body of the backplate includes opposing first and second backplate faces, and the mounting flange of the faceplate includes opposing first and second flange faces, the second backplate face being substantially flush with the second flange face when the backplate is located in the mounting flange of the faceplate.

18. The method of claim 15, wherein the planar backplate body of the backplate includes a first plurality of fastener holes each configured to receive therethrough a respective first fastener to thereby mount the backplate to the wall surface of the wall, and wherein the mounting flange of the faceplate includes a second plurality of fastener holes each configured to receive therethrough a respective second fastener to thereby mount the faceplate to the wall surface of the wall.

19. The method of claim 15, wherein the backplate includes a backplate sealing rib projecting from a rear backplate face of the planar backplate body, the backplate sealing rib configured to press against and seal to the wall surface of the wall, and wherein the faceplate includes a faceplate sealing rib projecting from a rear flange face of the mounting flange, the faceplate sealing rib configured to press against and seal to the wall surface of the wall.

20. The method of claim 15, wherein forming the backplate includes integrally forming the backplate as a first single-piece structure with a first polymeric material, and wherein forming the faceplate includes integrally forming the faceplate as a second single-piece structure with a second polymeric material.
